(19) United States
(12) Patent Application Publication
(10) Pub. No.: US 2015/0128748 A1
(43) Pub. Date: May 14, 2015

(54) ROTARY TRANSMITTER FOR ROBOTS

(71) Applicant: Andreas Rueb, Ditzingen (DE)

(72) Inventor: Andreas Rueb, Ditzingen (DE)

(21) Appl. No.: 14/376,587

(22) PCT Filed: Jan. 2, 2013
(86) PCT No.: PCT/EP2013/050004

§ 371 Date: Aug. 4, 2014

(30) Foreign Application Priority Data
Feb. 6, 2012 (DE) 102012201695.3

(51) Int. Cl. B25J 19/00

(52) U.S. Cl. CPC B25J 19/0041
USPC 74/490.02

(57) ABSTRACT

A rotary transmitter for a robot includes: a cylindrical stator having a centric opening in a floor, and a rotor accepted in the centric opening in the floor so as to be capable of rotation, and at least one line guided through the opening in the jacket surface of the stator. A segment of the line is slackly guided on an inner wall of the stator, and the segment has a length such that the line can follow a rotation of the rotor about an angle of rotation in a manner free of tensile load.

### BRIEF SUMMARY OF THE INVENTION

A rotary transmitter for a robot is proposed that is situated on the end of a robot arm and bears a tool, a sensor, a control or testing device, or the like. The rotary transmitter includes a stator that is essentially cylindrical and that has a centric opening in its floor.

In addition, an opening is fashioned on the jacket surface of the stator. In addition, the rotary transmitter has a rotor that is accepted in the centric opening in the floor of the stator. The rotor has a jacket surface in which an opening is fashioned. Through the opening in the jacket surface of the stator there is guided a line that is accepted at one end in the opening on the jacket surface of the rotor. Here, the line extends through an intermediate space between the stator and the rotor. In the intermediate space, in addition a plurality of guide rollers is accepted. The stator is closed by a cover that has a centric opening in which an end face of the rotor is accepted. Here, the cover is fashioned so as to form a fixed connection with one end of the robot arm, a torque-transmitting coupling being ensured between the rotor and a drive flange on the end of the robot arm. In addition, in the stator a segment of the line is guided slackly on an inner wall. Here, the segment has a length that permits following without tensile load when the rotor is rotated about an angle of rotation. In addition, the guide rollers follow the rotational motion in a circumferential direction, and each rotates about a separate axis. The guide rollers are here guided in an essentially annular roller bearer that follows a rotational movement in the circumferential direction.

In a preferred specific embodiment of the present invention, the line is fashioned as an electrical line and/or as a data line and/or as an optical fiber and/or as a fluid line. In addition, the line can also be realized as a ribbon cable. In addition, the rotary transmitter can be fashioned such that a plurality of lines is accepted in the stator, each guided into the stator through a separate opening in the jacket surface.

The openings in the jacket surface of the stator are fashioned in the shape of slots, and preferably have identical angular spacings from one another, dividing the jacket surface of the stator into equally large circumferential segments. In addition, the guide rollers in the intermediate space between the rotor and the stator can be mounted rotatably on an axle. Here, the axles are situated on an annular roller bearer that is placed into the stator. In addition, the at least one line guided through the intermediate space between the rotor and the stator is mounted in each case with a clamping plate in the area of the opening on the outer jacket surface of the stator or of the rotor.

In a preferred specific embodiment of the present invention, the rotary transmitter has a cable housing that is fashioned on the outer jacket surface of the stator. In the cable housing, lines that exit the stator are brought together and are connected to a pre-positioned cabling of the robot. Here, lines that do not exit the stator in the area of the cable housing are guided to the cable housing so as to lie on the outer jacket surface of the stator.

In a particularly preferred specific embodiment of the present invention, the length of the segment of the line that is situated between the stator and the rotor is realized having a length such that the line permits following of the rotation of the rotor about ±360° without tensile load.

In addition, the stator inner wall, the jacket surface of the rotor, and/or the jacket surfaces of the guide rollers can be fashioned such that they enter into an adhesive coupling with the line.

In a further preferred specific embodiment of the present invention, the rotary transmitter has at least five guide rollers.

The rotary transmitter for a robot according to the present invention provides a possibility for connecting components such as control devices, sensors, or tools, to one another via lines, the connection extending via a rotatable end of a robot arm. Here, the line is subject only to minimal mechanical loading, and in specific embodiments in which a plurality of lines are used, knotting or tangling of the lines is prevented. The lines remain in an orderly state in which the lines do not interfere with each other in their movement. The rotatable end of the robot arm here has a high degree of freedom of movement in the rotational direction.

The plurality of guide rollers ensures a simple and efficient guiding of the line. When the line is unwound from the rotor, in particular a return of the line on the inner wall of the stator is ensured by the guide rollers. The guide rollers define intermediate spaces and separate different lines, and prevent knotting or tangling of the lines. In addition, the slackness of the line enables easy following of a rotational movement of the rotor and low-load lying on the jacket surface of the rotor, the guide roller, and the inner wall of the stator.

The rotary transmitter according to the present invention can accommodate a large number of types of lines and can integrate them in one robot arm. The line can be realized as an electrical line, as a data line, as an optical fiber, as a fluid line, or as a combination of these. Consequently, a broad spectrum of use is ensured. If the line is realized, in a further advantageous manner, as a ribbon cable, then the lying of the line on the inner wall of the stator, the jacket surface of the rotor, and the jacket surface of the guide roller is improved. In this way, the above-described advantageous action of the named components is further increased.

In addition, the proposed rotary transmitter permits acceptance of a plurality of lines, and permits a corresponding number of openings to be provided for the lines at the stator and at the rotor. Here, each line is assigned a separate opening on the stator and on the rotor. In addition, a slot-shaped realization of the openings permits the lines to be introduced into the stator alongside one another, almost tangentially, and permits them to lie immediately against the inner wall of the stator. In this way, deformations, such as kinks, are avoided that could result in cable breakages or jamming in the lines. In addition, a situation of the slot-shaped openings on the outer jacket surface of the stator with uniform spacings in the circumferential direction of the stator, or equal angular spacings relative to a midpoint of the stator, enables an efficient use of the internal space of the stator. In addition, here the lines have a maximal spacing during operation, so that on the inner wall of the stator regions are minimized in which two lines are situated one over the other. In this way, long segments of the lines are prevented from rubbing against one another, and wear, during operation.

In addition, a plurality of rotatable guide rollers in the intermediate space between the stator and the rotor, having equal angular spacings from one another, ensure an efficient use of the interior space of the stator. A line guided along the jacket surface of the rotor is guided by uniformly spaced guide rollers so as to be free of interruptions, and detachment from the jacket surface of the rotor is prevented. A line that detaches from the jacket surface of the rotor and extends into the intermediate space in the shape of a loop can be caught by the stator and carried along. This would cause damage to the line, and would thus cause impairment of the functioning of the rotary transmitter. A configuration of the guide rollers with uniform angular spacings increases the robustness of the rotary transmitter. In addition, the use of at least five guide rollers permits a stable and smooth actuation of the rotary transmitter.

In addition, an exemplary embodiment of the rotary transmitter according to the present invention, in which the guide rollers are each mounted on a respective axis situated on an annular roller bearer, enables a simple assembly. Here, the plurality of guide rollers assume their final installed position on the annular roller bearer immediately upon being introduced into the stator. It is possible to test the functionality of the rotary transmitter during the assembly. In the case of an error in assembly, a costly re-opening of the rotary transmitter is avoided. The rotary transmitter according to the present invention is easily retrofitted, thus increasing the flexibility of use. In addition, the roller bearer ensures equal angular spacings of the guide rollers from one another, and prevents rotating guide rollers from coming into contact. If rotating guide rollers come into contact during operation, their jacket surfaces moving against one another cause friction that disturbs a uniform and smooth running of the rotary transmitter.

In addition, a clamping plate for fastening the line on the outer jacket surface of the stator and/or rotor ensures increased robustness and error tolerance of the rotary transmitter. The clamping plate relieves tensile forces on the segment of the line between the stator and the rotor. Such tensile forces can be produced by the pre-positioned cable guiding. In addition, the fastening of the line to the clamping plate prevents the line from being pulled into an opening of the rotor or stator when there is an actuation of the rotary transmitter. Pulling in of the line is connected with a high risk of damage or breakage of the line. If a break or damage to the line occurs, this will cause the robot to fail.

In addition, an exemplary embodiment of the rotary transmitter is preferred in which the lines on the inner wall of the stator are routed in the same circumferential direction from the entry into the stator to the entry into the rotor. In this way, the space in the stator is used efficiently. In addition, the segment of the line that extends outside the stator is guided along the outer jacket surface thereof into the region of a cable housing. In this way, the associated end of the line can be easily fastened, covered, and contacted. Here it is particularly advantageous if the cable housing is provided in its interior with contact points that are coupled to standardized plugs attached on an outer side of the cable housing. In this way, a compact interface is created by which the sensors, control devices, or tools connected via the line can be integrated into the robot.

In a further advantageous specific embodiment, the rotary transmitter is fashioned in such a way that a rotation, free of tensile load, of the rotary transmitter about an angle of rotation of +/−360° is possible. An angle of rotation of +/−360° provides the robot with a working range that permits a broad spectrum of operations.

In a further advantageous specific embodiment, a detachment of the line from the stator inner wall, the jacket surface of the rotor, and/or jacket surfaces of the guide rollers is counteracted in that the stator inner wall, the jacket surface of the rotor, and/or the jacket surfaces of the guide rollers are fashioned such that upon contact with the line an adhesive coupling is present.

### BRIEF DESCRIPTION OF THE DRAWINGS

FIG. 1 shows an oblique view of the rotary transmitter in the partially assembled state.

FIG. 2 shows a schematic exploded view of the rotary transmitter.

FIG. 3 shows a top view of the rotary transmitter without cover.

### DETAILED DESCRIPTION OF THE INVENTION

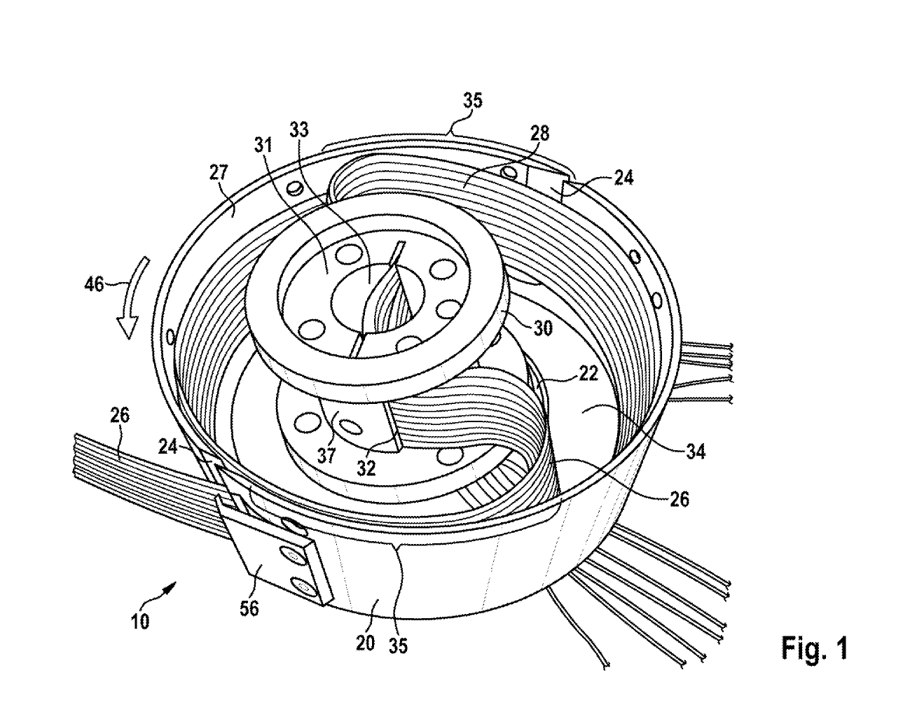

FIG. 1 shows a stator 20 in which a rotor 30 is accepted. Stator 20 has for this purpose a centric opening 22 in its floor in which rotor 30 is rotatably mounted. Stator 20 has on its jacket surface openings 24 that are fashioned in the shape of slots. Lines 26, which can be realized as a ribbon cable, are guided through slot-shaped openings 24. In addition, lines 26 enter at openings 24 in the jacket surface of stator 20 in a practically tangential manner. In this way, kinks in lines 26 are prevented, and damage, e.g. cable breakages, are also prevented. Lines 26 are fastened at opening 24 by clamping plates 56. In addition, lines 26 lie in a region on inner wall 27 of stator 20 between the entry into stator 20 and their acceptance in opening 32 on rotor 30. In addition, lines 26 are routed with slack and in the same circumferential direction 46. Between stator 20 and rotor 30, there is an intermediate space 34 that is fashioned to accept guide rollers 40. For clarity, guide rollers 40 are not shown in FIG. 1. In addition, line segments 28 of two lines 26 are fashioned on a stator inner wall 27, in which two lines 26 lie one over the other, and form an overlapping segment 35. An end face 31 of rotor 30 is fashioned having a mechanical interface 33, and ensures a torque-transmitting connection to a drive flange on the end of the robot arm with which rotary transmitter 10 is connected during operation. Rotor 30 has openings 32 in each of which a line 26 is accepted. Here, jacket surface 37 of rotor 30 is fashioned to accept clamping plates 56.

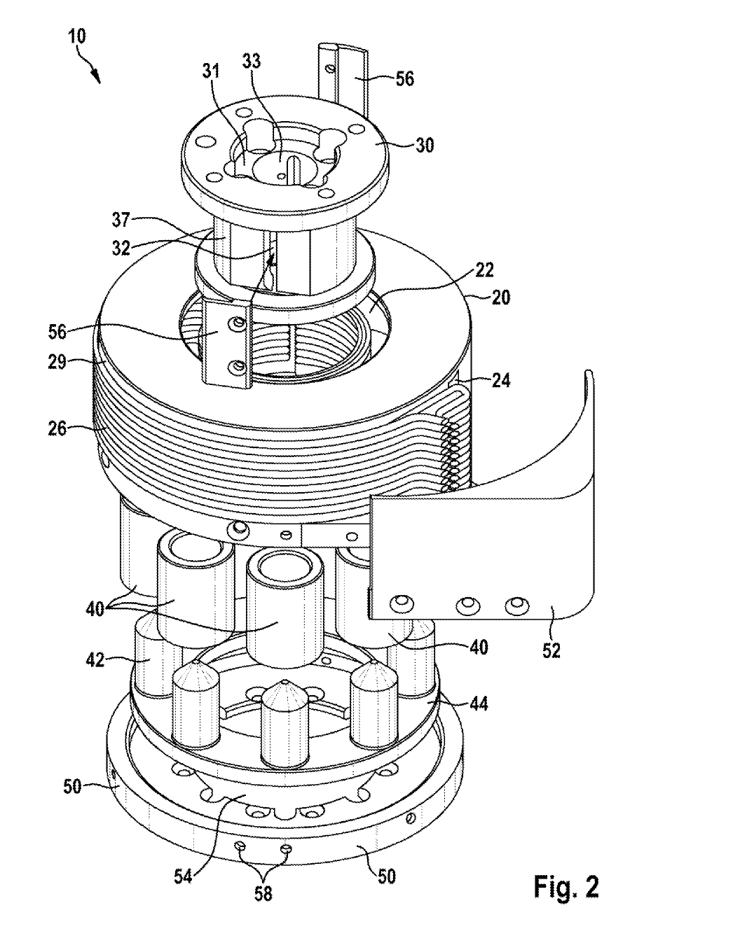

FIG. 2 schematically shows an exploded view of the assembled rotary transmitter.

Stator 20 is closed by a cover 50 that has a centric opening 52 in which an end face 31 of rotor 30 is rotatably accepted. Cover 50 has, on a circumferential segment, fastening points 58 by which cover 50 is capable of being connected to stator 20 and to cable housing 52. Guide rollers 40 are situated in intermediate space 34 between stator 20 and rotor 30. Guide rollers 40 are rotatably mounted on axles 42, axles 42 being fashioned on a roller bearer 44. Here, roller bearer 44 is supported against cover 50. Line 26, guided in intermediate space 34 from stator 20 to rotor 30, has a segment, covered in FIG. 2, that extends between two guide rollers 40. Here, line 26 runs from segment 28 on stator inner wall 27 to opening 32 on rotor 30. When there is a rotational motion of rotor 30, line 26 lies against a guide roller 40. In this way, a guided unwinding of line 26 between guide rollers 40 and inner wall 27 of stator 20 is ensured. In addition, the guiding on guide roller 40 permits an unrolling of line 26 from rotor 30 without knotting or tangling of line 26 in intermediate space 34 between stator 20 and rotor 30. In line segment 28 on stator inner wall 27, guide rollers 40 prevent detachment of line 26 from stator inner wall 27. In addition, guide rollers 40 prevent detachment of line 26 from jacket surface 37 of rotor 30.

The segment of the line that extends outside stator 20 is guided along outer jacket surface 29 of stator 20 in the region of a cable housing 52. In the region of cable housing 52, the ends of lines 26 are brought together, and are contacted in cable housing 52. Cable housing 52 can have, on an outer side, terminals that are connected to lines 26. The terminals produce a connection between lines 26 and the robot arm. During operation, cable housing 52 is immovable, and represents an interface by which line 26 is connected to the pre-positioned cabling of the robot arm.

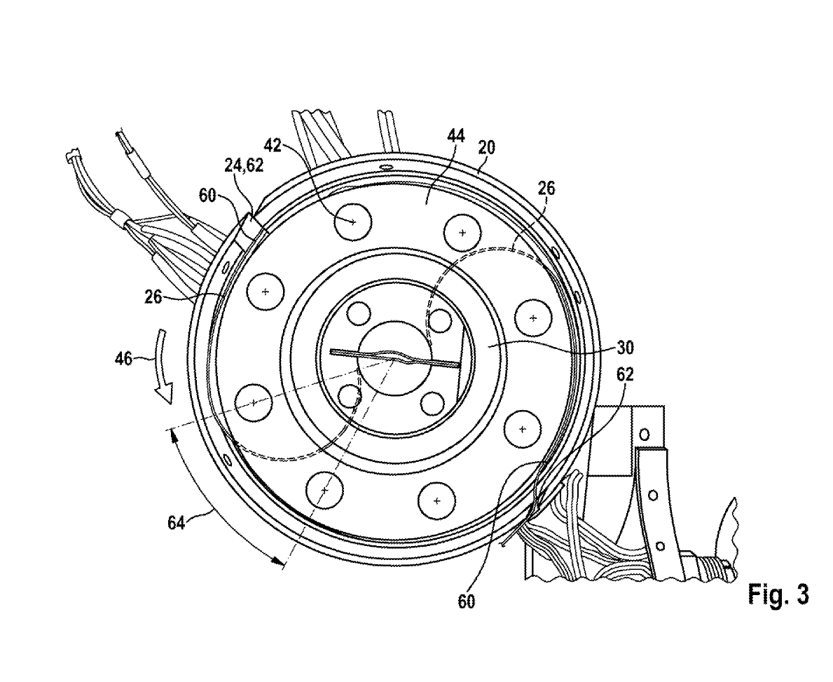

FIG. 3 is a top view of an opened rotary transmitter 10. In stator 20, rotor 30 is centrically accepted so as to be capable of rotation. Lines 26 enter intermediate space 34 at openings 24 on stator jacket surface 29. Here, lines 26 enter intermediate space 34 in a tangential entry 62, and run in the same circumferential direction 46. Lines 26 are guided in stator 20 by guide rollers 40, each mounted on an axle 42 so as to be capable of rotation. Axles 42 are fashioned on an annular roller bearer 42, which in FIG. 3 covers guide rollers 40. In addition, axles 42 and guide rollers 40 have identical angular spacings 64 from one another. A line routing 60 arises in which, on a guide roller 40, line 26 detaches from inner wall 27 of stator 30 and runs between two guide rollers 40 to rotor 30, in the direction opposite circumferential direction 46.

The components of rotary transmitter 10 are easily accessible, and can easily be disassembled and checked. In the assembled state according to FIG. 3, a simple functionality test of rotary transmitter 10 is possible. Errors in assembly that may occur can easily be determined and corrected.

1-18. (canceled)

19. A rotary transmitter for a robot, comprising:
a stator having a centric opening in a floor;
a rotor accommodated in the centric opening in the floor and configured for rotation; and
at least one line, wherein a segment of the line is guided slackly on an inner wall of the stator, and wherein the segment has a length which enables the line to follow a rotation of the rotor about an angle of rotation without tensile loading.

20. The rotary transmitter as recited in claim 19, wherein the stator has an opening on a jacket surface of the stator.

21. The rotary transmitter as recited in claim 20, wherein the rotor has an opening on a jacket surface of the rotator.

22. The rotary transmitter as recited in claim 21, wherein the line is guided through the opening in the jacket surface of the stator, and is accepted at an end in the opening of the jacket surface of the rotor.

23. The rotary transmitter as recited in claim 21, further comprising:
multiple guide rollers configured to rotate in an intermediate space between the stator and the rotor.

24. The rotary transmitter as recited in claim 21, further comprising:
a cover which closes the stator, wherein the cover has a centric opening which accommodates an end surface of the rotor.

25. The rotary transmitter as recited in claim 24, wherein the cover is configured for a fixed connection to an end of a robot arm, and wherein the rotor is coupled in torque-transmitting fashion to a drive flange at the end of the robot arm.

26. The rotary transmitter as recited in claim 22, wherein the line is at least one of an electrical line, a data line, an optical fiber line, and a fluid line.

27. The rotary transmitter as recited in claim 26, wherein the line is fashioned as a ribbon cable.

28. The rotary transmitter as recited in claim 22, wherein multiple lines are accepted in the stator, each line being guided into the stator through a respectively separate opening in the jacket surface of the stator, and being accepted in a respectively separate opening on the rotor.

29. The rotary transmitter as recited in claim 28, wherein the openings in the jacket surface of the stator are in the shape of slots and have identical spacings from one another.

30. The rotary transmitter as recited in claim 23, wherein the multiple guide rollers are situated at identical angular spacings from one another.

31. The rotary transmitter as recited in claim 23, wherein the multiple guide rollers are each rotatably mounted on a respective axle which is situated on an annular roller bearer.

32. The rotary transmitter as recited in claim 22, further comprising:
a mountable clamping plate, wherein the at least one line is fastened on the mountable clamping plate, and wherein the mountable clamping plate is attached at least one of in the area of the opening on the outer jacket surface of the stator and in the area of the opening on the outer jacket surface of the rotor.

33. The rotary transmitter as recited in claim 28, wherein the lines are attached on the inner wall of the stator in the same circumferential direction.

34. The rotary transmitter as recited in claim 22, wherein a further segment of the at least one line is situated outside the stator and is guided to a cable housing while lying against the outer jacket surface of the stator, and wherein the cable housing is configured to contact and cover the end of the at least one line.

35. The rotary transmitter as recited in claim 22, wherein the angle of rotation of the rotor at which the at least one line follows a rotation of the rotor in a manner free of tensile load is +/−360°.

36. The rotary transmitter as recited in claim 22, wherein a portion of the at least one line (i) detaches from the inner wall of the stator on a guide roller in the circumferential direction, and (ii) extends between two guide rollers to the rotor in a direction opposite the circumferential direction.
